(19) United States
(12) Patent Application Publication
(10) Pub. No.: US 2012/0047119 A1
(43) Pub. Date: Feb. 23, 2012

(54) SYSTEM AND METHOD FOR CREATING AND NAVIGATING ANNOTATED HYPERLINKS BETWEEN VIDEO SEGMENTS

(75) Inventors: Kunal Kandekar, Jersey City, NJ (US); Michael W. Helpingstine, Chapel Hill, NC (US); Ravi Reddy Katpelly, Durham, NC (US)

(73) Assignee: PORTO TECHNOLOGY, LLC, Wilmington, DE (US)

(21) Appl. No.: 12/840,864

(22) Filed: Jul. 21, 2010

Related U.S. Application Data
(60) Provisional application No. 61/227,202, filed on Jul. 21, 2009.

(51) Int. Cl. G06F 17/30

(52) U.S. Cl. 707/705; 707/802; 707/E17.044

(57) ABSTRACT

Systems and methods are provided for linking and playing media content from one or more media items. Linking items may be stored with a plurality of other linking items and associated with one or more media items. The linking items define media fragments within the media items and media segments linked to the media items. By selecting linking items associated with a particular media item, a user can dynamically select the media segments linked to the media item.

### RELATED APPLICATIONS

This application claims the benefit of provisional patent application Ser. No. 61/227,202, filed Jul. 21, 2009, the disclosure of which is hereby incorporated herein by reference in its entirety.

### FIELD OF THE DISCLOSURE

The present invention relates generally to systems and methods of linking and playing media content.

### BACKGROUND

Various technologies now exist which allow a user to search for and play media items. Cable and satellite systems, personal computers, portable media players, and other similar devices may be networked into a database or a peer-to-peer (P2P) network to provide access to stored media items. Often the media content in these media items may be interrelated for a plurality of reasons. For example, a song from one audio item may be artistically inspired by a song from another audio item. A segment from one movie item may include a parody of a scene from a segment on a different movie item. Similarly, users may desire to communicate political ideas by comparing the statements of a politician or commentator on one video item with statements on another video item.

Thus, there is a need for a system and method that enables users to quickly and easily link and play related segments of the same or different media items.

### SUMMARY

Systems and methods are provided for linking and playing media content. In one embodiment, a computational device creates a linking item that links a media fragment within a media item to a media segment of the same or a different media item. More specifically, the computational device receives a first user input defining the media fragment within the media item and a second user input defining the media segment. Based on this user input, the linking item is created by the computational device and associated with the media item. This linking item links the media fragment within the media item to the media segment. The computational device then stores the linking item.

A media player may then receive this linking item from the computational device to play linked media content. This linking item provides instructions executed by the media player during playback of the media item. By executing the instructions on the linking item, the media player automatically detects when playback has reached the media fragment in the media item. The media player then plays the media segment linked to the media fragment in accordance with the instructions from the linking item. Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates one embodiment of a system for creating and playing linked media content.

FIG. 2 illustrates one embodiment of a method for creating linking items in accordance with the invention.

FIG. 3 illustrates additional details for the step of the method shown in FIG. 2 for selecting one or more media items to link media content.

FIG. 4 illustrates additional details for the step of the method shown in FIG. 2 for selecting a media fragment within a media item.

FIG. 5 illustrates additional details for the step of the method shown in FIG. 2 for selecting the media segment.

FIG. 6 illustrates a screenshot of one embodiment of a graphical interface for creating linking items in accordance with the invention.

FIG. 7 illustrates another screenshot of the graphical interface shown in FIG. 6.

FIG. 8 illustrates a text-based representation of one embodiment of a linking item.

FIG. 9 illustrates the operation of one embodiment of a linking item.

FIG. 10 illustrates the operation of another embodiment of a linking item.

FIG. 11 illustrates the operation of yet another embodiment of a linking item.

FIG. 12 illustrates the operation of two related linking items.

FIG. 13 illustrates the operation of still another embodiment of the linking item.

FIG. 14 illustrates the operation of three related linking items.

FIGS. 15A and 15B illustrate a first embodiment of a method for playing linked media content.

FIG. 16 illustrates a screenshot of one embodiment of a graphical interface.

FIG. 17 illustrates a second embodiment of a system for creating and playing linked media content.

FIG. 18 illustrates a third embodiment of a system for playing linked media content.

FIG. 19 illustrates a fourth embodiment of a system for playing linked media content.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

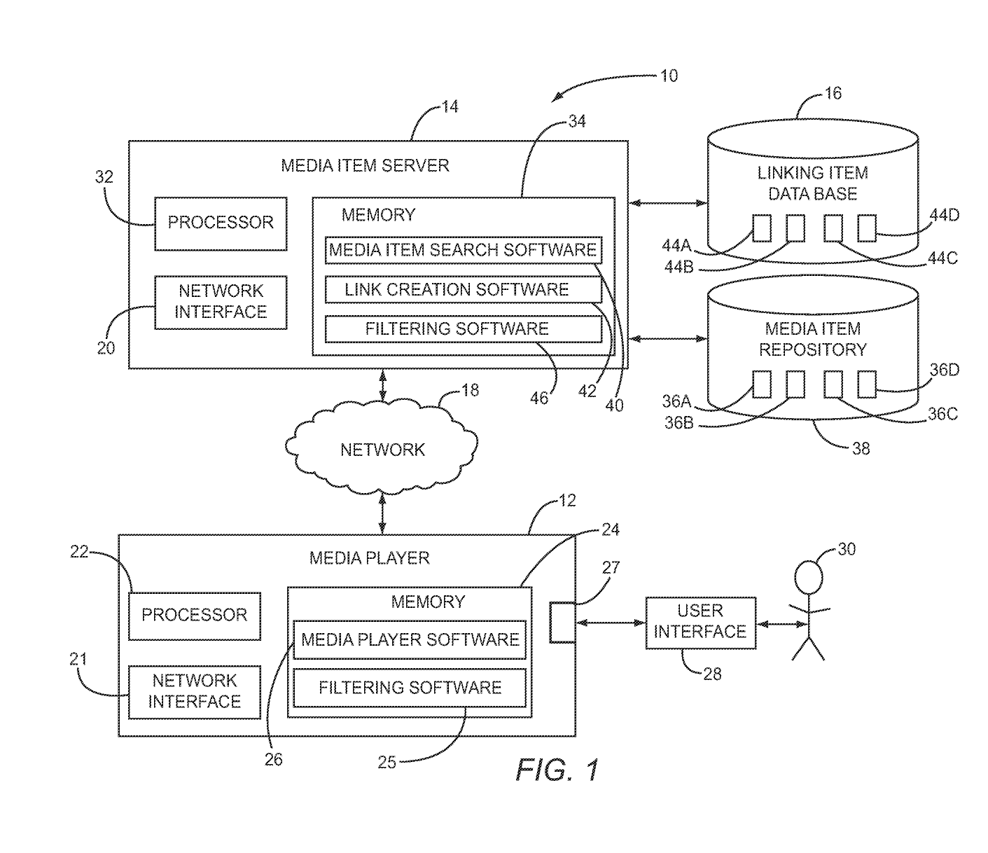

Systems and methods are provided for linking and playing media content from one or more media items. Media items may be any type of media item, including audio items such as songs; video items such as movies, television programs or movie clips; or the like. FIG. 1 illustrates one embodiment of a system 10 for linking and playing media items. The system 10 includes a media player 12 and a media item server 14 having a linking item database 16. The media player 12 and the media item server 14 are connected to one another via a network 18. The network 18 may be any type of network including a local area network (“LAN”), a wide area network (“WAN”), or the like and any combination thereof. Furthermore, the network 18 may include wired and/or wireless components. For example, the network 18 may be a publicly distributed network, such as the Internet.

The media player 12 and the media item server 14 include network interfaces 20, 21 for connecting to the network 18. The media player 12 includes a processor 22 and memory 24. The media player 12 may be any type of media player 12, including a personal computer, a portable media player, a digital video disc (DVD) player, a cell phone, a personal digital assistant (PDA), or any other type of device that can play media items. The memory 24 includes media item player software 26 that allows the media player 12 to play one or more types of media items. The media player 12 may be coupled to a user interface 28 that includes one or more output components such as a display, television, or speaker(s) and one or more input devices such as a keyboard, mouse, or button. The media item player software 26 generates audio/visual signals and transmits them via an output port 27 to the user interface 28. Audio/video signals may be signals in any type of format utilized by an output component of the user interface 28 to present media content to a user 30. The type of audio/visual signals generated by the media item player software 26 at the output port 27 will depend on the type of media player and display device being used to display media content to the user 30. In one embodiment, the media item player software 26 may be a web browser having the appropriate plug-ins. Also, note that while the user interface 28 is illustrated separately from the media player 12, the user interface 28 may be incorporated into the media player 12.

The media item server 14 includes a processor 32 operatively associated with memory 34. The media item server 14 also stores a plurality of media items 36A-36D (also referred to collectively as “media items 36” or individually as “media item 36”) at a media item repository 38 which is managed by the media item server 14. The memory 34 may store media item search software 40. The media item search software 40 is executed by the processor 32 to enable the media item server 14 to receive a search request from the user 30 and filter the media items 36 in accordance with the search request. The user 30 may select among these media items 36 to determine what media content to link or which media item 36 to play.

Next, the memory 34 may store link creation software 42 for creating linking items 44A-44D (also referred to collectively as “linking items 44” or individually as “linking item 44”) stored in the linking database 16. The linking items 44 link a media fragment within one media item 36 to a media segment from the same or a different media item 36. As is known in the art, media items 36 store media content as a continuous series of frames, typically in a compressed format. These frames are decompressed and played along consecutively for a period of duration to present the media content to a user. Consequently, each frame may be associated with a particular time location along this period of time. As used in this disclosure, a media fragment may be a single frame of media content located at a single time location within the media item 36. In the alternative, the media fragment may be a continuous series of frames having a starting and ending time location within the media item 36. Thus, this continuous series of frames for the media fragment would be a media segment within the media item 36. Accordingly, the media fragment may be defined to encompass a single frame located at a single time location within the media item 36, a media segment that includes a portion of the media content within media item 36, or the entire media item 36.

The media fragment is linked by the linking item 44 to another media segment discrete from the media fragment. This media segment may be from the same media item 36 or a different media item 36. The media segment linked to the media fragment is discrete from the media fragment either because the time locations of the media fragment do not overlap the time locations of the linked media segment within the same media item 36 or because the media segment is from a different media item 36.

User inputs from the user 30 may be received by the media item server 14 via the network interface 20 which define the media fragment and the media segment. The link creation software 42 in the memory 34 creates the linking item 44 utilizing the user input received from the network interface 20. This linking item 44 can then be stored within the linking item database 16. Note that while only the user 30 is shown, the linking items 44 may include linking items 44 created by numerous users. For instance, for a particular media item 36, numerous users, such as the user 30, may provide user inputs to create numerous linking items 44 linking media content to the same or a different media fragment within the particular media item 36. This linking item 44 can then be stored in the memory 34 and utilized by various users connecting to the media item server 14.

Filtering software 46 may be stored by the media item server 14 at memory 34. The filtering software 46, when executed by the processor 32, can receive a search request from the media player 12 to search for a desired linking item 44. The filtering software 46 analyzes the linking items 44 to determine which linking items 44 match some desired criteria. In some embodiments, the user 30 can then select among these linking items 44 to determine the media segments which are to be played by the media player 12. Note that while the linking item database 16 and the media item repository 38 are managed by the media item server 14, both the linking item database 16 and the media item repository 38 may be managed remotely from another computational device.

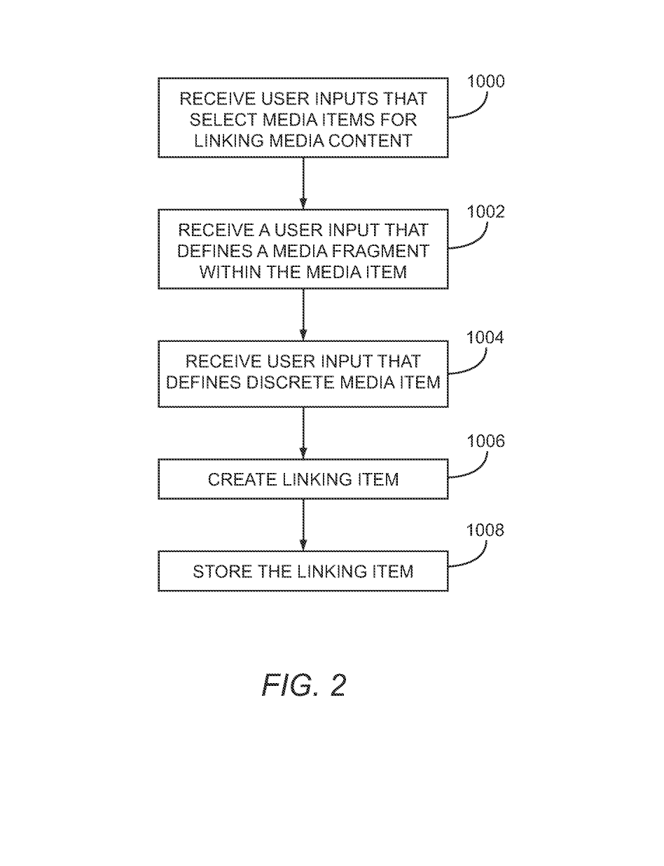

FIG. 2 illustrates one embodiment of a method for creating linking items 44 which may be performed by the link creation software 42. First, the user 30 selects one or more media items 36 for linking media content (step 1000). To accomplish this, the media item server 14 may receive user inputs indicating the media items 36 selected by the user 30. For example, the media item server 14 may receive user inputs identifying a single media item 36. If this media item 36 is a movie with related but temporally distant scenes, the user 30 may want to link the related scenes within the same movie. Accordingly, the user 30 would only select the single media item 36 since both of the linked scenes are from the same movie. Alternatively, the user 30 may want to link media content from different media items 36. For example, the media item 36 may be a video clip having a speech from a politician. The user 30 may believe that the politician has made inconsistent statements in another speech recorded in a different media item 36 which may be an audio clip. Thus, the media item server 14 may receive user inputs selecting both the media item 36 for the video clip and the audio clip so that the user 30 can link the different portions of each speech utilizing the link creation software 42.

The user 30 may then transmit user inputs that define the media fragment within a media item 36 and a media segment within the same or a different media item 36. The media item server 14 receives these user inputs (steps 1002 and 1004). As mentioned above, this media fragment may be located at a single time within the media item 36 or may be a media segment having a starting and ending time location within the media item 36. The media segment linked to this media fragment may be from the same or a different media item 36. The link creation software 42 receives the user inputs defining the media fragment either simultaneously in one data message or separately in separate data messages to create one of the linking items 44 (step 1006). This linking item 44 may then be stored in the linking item database 16 for later retrieval (step 1008).

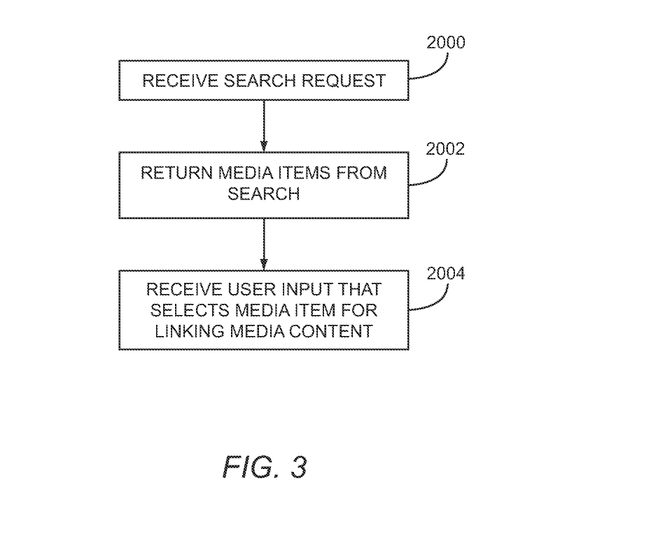

FIGS. 3-5 illustrate additional details of steps 1000-1004 for creating a linking item 44. Referring now specifically to FIG. 3, additional details are shown for selecting one or more media items 36 for linking media content (step 1000 in FIG. 2). The user 30 may input a search request to the media item server 14. The search request may include text describing a desired media item 36 which is received by the media item server 14 (step 2000). The media item search software 40 may be a search engine which receives the search request describing a desired media item(s) and compares it to information, such as metadata, about stored media items 36. The media item search software 40 then determines which of the media items 36 (if any) in the media item repository 38 match or are similar to the desired media items 36 based on the search request. The media item server 14 then returns these media items 36 to the media player 12 (step 2002). The user 30 then selects one or more media items 36 for linking media content (step 2004).

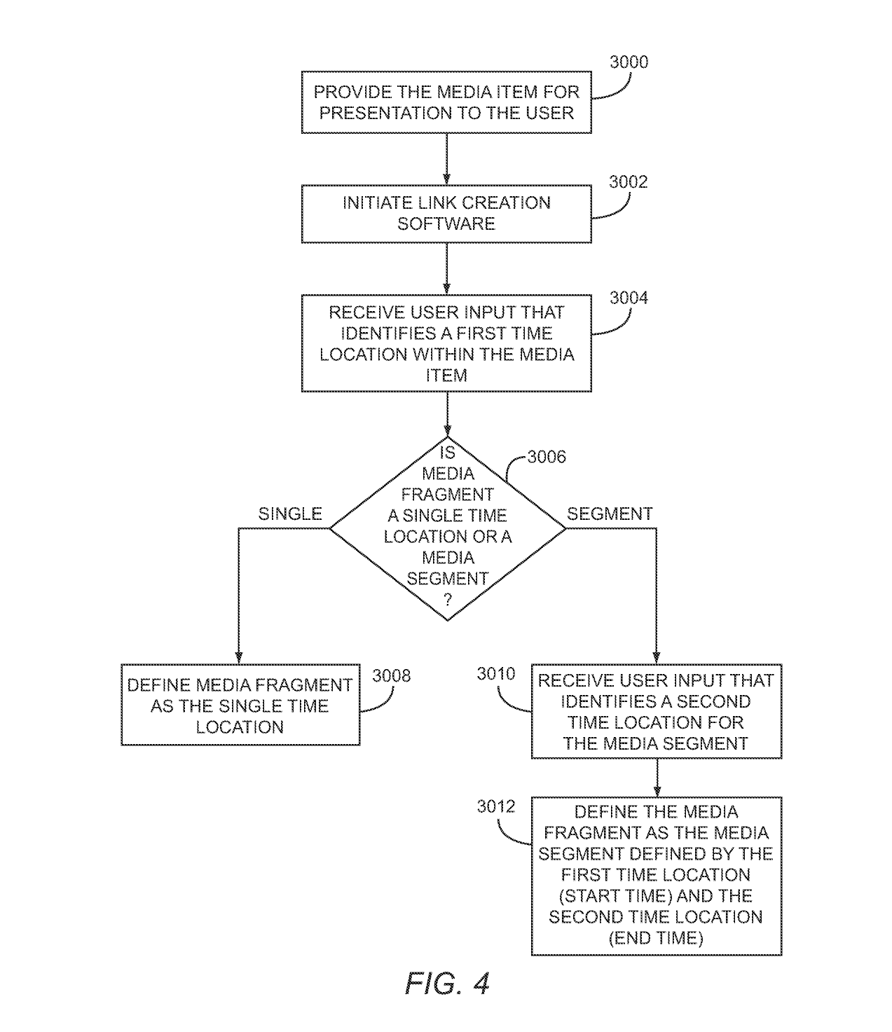

FIG. 4 illustrates additional details for receiving a user input that defines a media fragment within the media item 36 (step 1002 in FIG. 2). In one embodiment, as will be explained in more detail below, the media item 36 may be presented to the user 30 via a graphical interface utilizing the link creation software 42 within the linking item database 16. The media item server 14 provides the media item 36 to the media player 12 for presentation to the user 30 (step 3000) and the link creation software is initiated by the media item server 14 (step 3002). The user 30 may then enter a user input for a first time location for the media fragment which is received by the media item server 14 (step 3004). The link creation software 42 may then determine whether the media fragment within the media item 36 is a single frame located at a single time location within the media item 36 or if the media fragment will be a media segment having a starting and ending time location within the media item 36 (step 3006). This determination may be made based on, for example, selection by the user 30. If the media fragment is a single frame at a single time location, the user 30 does not enter any additional time locations for the media fragment and the media item server 14 defines the media fragment as a single time location (step 3008). The link creation software 42 also may be pre-configured to set the time location at a particular time location in the media item 36. For example, if the user 30 fails to define a time location for the media fragment, the link creation software 42 may automatically select the frame located at the final time location of the media item 36 as the media fragment.

On the other hand, the user 30 may enter a second time location to define the media fragment as a media segment. The media item server 14 receives user input that identifies this media segment (step 3010). The starting time location of the media segment is defined by the first time location entered by the user 30 and the ending time location is defined by the second time location entered by the user 30 (step 3012). The link creation software 42 may also be pre-configured to set the start and end time for the media fragment. For example, if the user 30 fails to define one or both of the time locations for the media fragment, the link creation software 42 may automatically select the starting and/or final time locations of the media item 36. In another embodiment, video analysis techniques such as scene detection may be employed to automatically identify the start and end times of each scene in the media item 36, for example of the media item 36 is a video. Thus, if the media fragment is to be defined as a media segment within the media item 36, the start and end times of the media fragment may be automatically selected by the link creation software 42 as the start and end times of the scene in which the user-selected time location belongs. Hence, the user 30 may have to only select a single time location to define the media fragment within the media item 36 as a media segment. If the media item 36 is being presented to the user 30 via a graphical interface during the selection of the media fragment, the automatically selected fragment may be indicated to the user as time offsets for the media fragment within the media item 36. In the alternative, the automatically selected fragment may be indicated as a highlighted segment of a visual timeline for the media item that corresponds to the automatically selected fragment. Additional details of the graphical interface are explained below. In still another embodiment, a fixed pre-configured amount of time, say 10 seconds, before and after the user-selected time location may be used to automatically select the starting and end times of the media fragment.

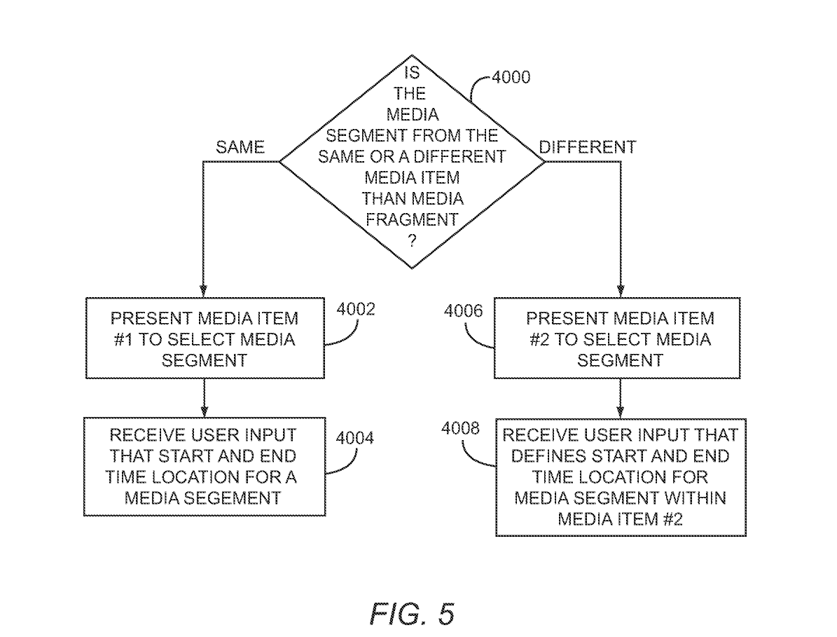

FIG. 5 illustrates additional details for receiving user input that defines a discrete media segment linked to the media fragment (step 1004 in FIG. 2). The link creation software 42 determines if the media segment to be linked to the media fragment is from the same or a different media item 36 (step 4000). In either case, the media segment is discrete from the media fragment because the media segment is either located at non-overlapping time locations within the same media item 36 or the media segment is from a different media item 36 than the media fragment. If the media segment is from the same media item 36, the link creation software 42 may present the media item 36 to the user 30 (step 4002). The user 30 may then enter time locations corresponding to the starting and ending time locations of the media segment (step 4004). The link creation software 42 also may be pre-configured to set the start and end time for the media segment automatically. For example, if the user 30 fails to define one or both of the starting and ending locations for the media item 36, the link creation software 42 may automatically select the first and/or final time locations of the media item 36. In another embodiment, the link creation software 42 may apply scene detection methods to automatically select the start and end time locations of the media segment in which a single user-defined time location belongs.

Next, if on the other hand, the media segment is from a different second media item 36, the link creation software 42 may present the second media item 36 to the user 30 (step 4006). The user 30 may then select the starting and ending time locations of the media segment from the second media item 36 (step 4008). The link creation software 42 also may be pre-configured to set the start and end time for the media segment in the second media item 36. For example, if the user 30 fails to define one or both of the starting and ending locations for the media segment, the link creation software 42 may automatically select the first and/or final time locations of the second media item 36. In another embodiment, the link creation software 42 may apply scene detection methods to automatically select the start and end time locations of the media segment in which a single user-defined time location belongs. The link creation software 42 then utilizes user inputs defining the media fragment and the media segment to create and store the linking item 44 in the linking item database 16 (steps 1006 and 1008 in FIG. 2).

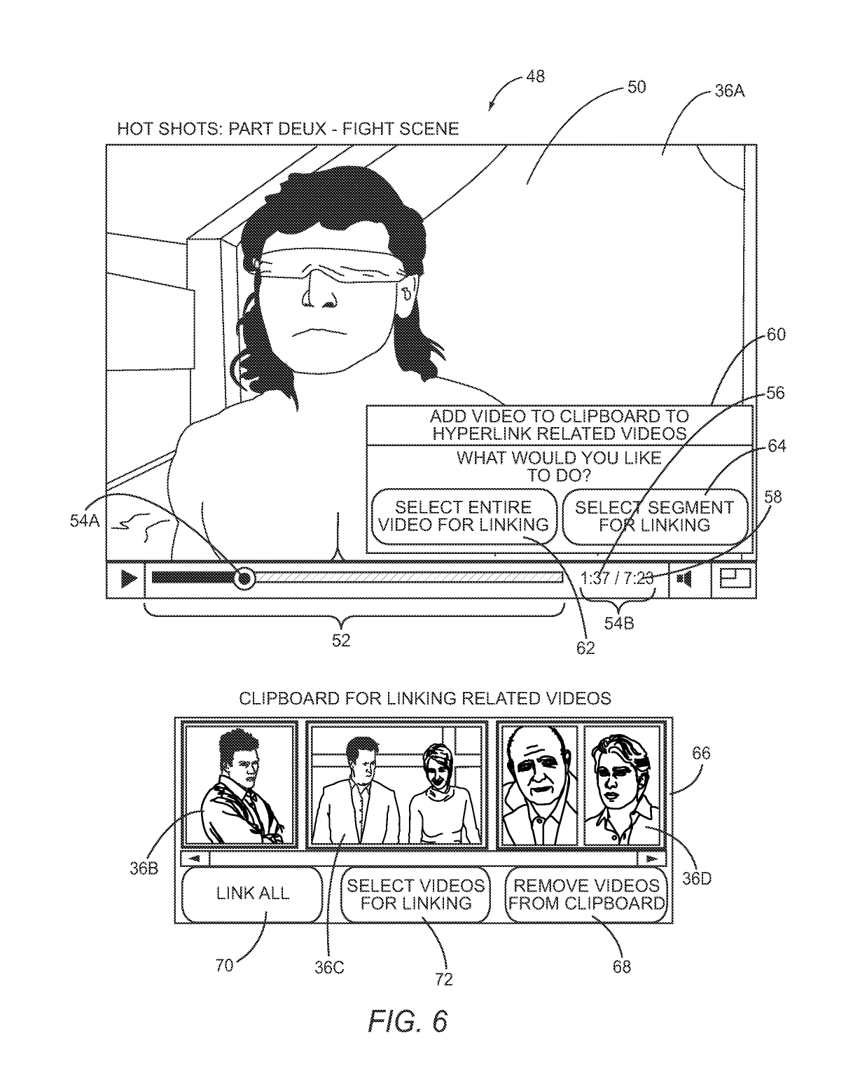

FIG. 6 illustrates a screenshot of a graphical interface 48 for creating the linking item 44. The graphical interface 48 may be rendered by the processor 22 of the media player 12 and displayed to the user 30 via a monitor in the user interface 28. Also, the graphical interface 48 may or may not allow the user 30 to create a linking item 44 in the same order as the steps described above. In this example, the user 30 is creating a linking item 44 to link the media fragment within one of the media items 36 to a media segment within a different media item 36. Also, in this example, the media items 36 are movies. The graphical interface 48 includes an object 50 which presents the first media item 36 to the user 30. The object 50 also includes a visual timeline 52 corresponding to time locations in the media item 36, also often referred to as a “scrub bar”, and time location indicators 54A and 54B. The time location indicator 54A indicates the particular location along the visual timeline 52 where the first media item 36 is being presented. The time location indicator 54A moves along the visual timeline 52 to indicate the current time location when the first media item 36 is being presented to the user 30 and can be manipulated to skip to different time locations in the first media item 36. The time location indicator 54B provides a time offset 56 for the current location of the first media item 36 being presented relative to a total time 58 of the first media item 36. The time offset 56 also changes in accordance to the current time location of the first media item 36 being presented to the user 30.

A media item selection indicator 60 in the object 50 includes options buttons 62, 64 to select and link media content to the first media item 36. If the option button 62 is selected, the media fragment linked within the first media item 36 will automatically be the first and last time locations of the first media item 36. On the other hand, if the option button 64 is selected, the user 30 may select a particular media fragment within the first media item 36. In this case, the graphical interface 48 is preconfigured so that the media fragment is a media segment instead of a single frame. To enter the starting and ending time locations of the media segment, the user 30 may enter text or manipulate the time location indicator 54A. In an alternate embodiment, scene detection methods are applied and the scene in which the user-selected location or the current playback location belongs is automatically selected as the media segment. The selected starting and ending times may be depicted visually on the timeline (or “scrub bar”) 52, such as by highlighting the section of the visual timeline 52 that corresponds to the selected starting and ending times. Highlighting may include changing the color of the segment, or overlaying markers at the starting and ending locations, or a combination of the two, and the like. Upon selecting either option button 62 or 64, the first media item 36 is presented in a clipboard object 66.

The clipboard object 66 presents a plurality of media items 36, in this case movies, for linking media content. The user 30 has already presented these media items 36 in the object 50 and selected the relevant media segments. The clipboard object 66 includes a “Remove Videos From Clipboard” button 68 that permits the user 30 to remove one of the media items 36 from the clipboard object 66. A “Link All” button 70 allows the user 30 to link the media segments of all of the plurality of media items 36 in the clipboard object 66 to one another. This will be explained in further detail below. A “Select Videos for Linking” button 72 allows the user 30 to link one or more of the media segments from one of the plurality of media items 36 in the clipboard object 66 to the selected media fragment within the first media item 36. In this example, the user 30 utilizes the “Select Videos for Linking” button 72 to link a media fragment from the first media item 36 to a media segment from a second media item 36. Note that in other embodiments, other methods may be used to perform the same functions. For example, instead of using buttons 70, 72 and 68, the interface enables graphical operations, such as drag-and-drop, to enable linking of two or more segments. For example, the user 30 may use a mouse pointer or touch interface to click on one segment, either in the video object 50 or the clipboard object 66, and then drag and drop it to another segment in the video object 50 or clipboard object 66.

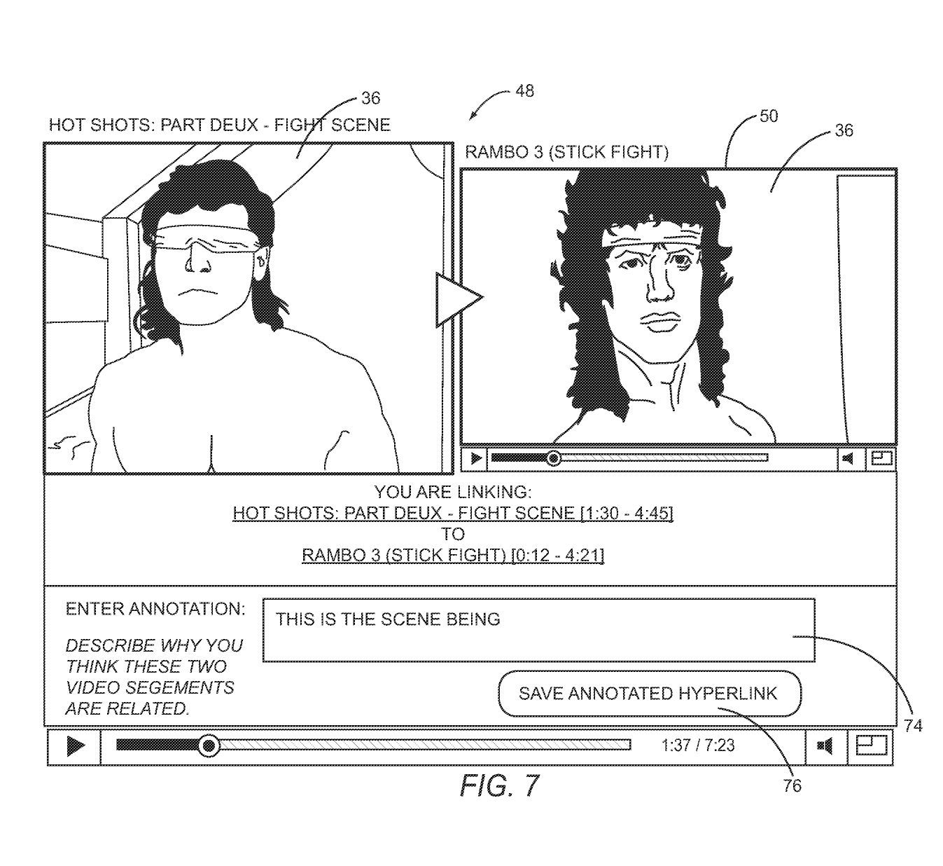

FIG. 7 illustrates a screenshot from the graphical interface 48 of the object 50 after a media fragment within the first media item 36 has been selected for linking to the media segment from the second media item 36. The object 50 may present both media items 36 at the starting locations for the media fragment and media segment, respectively. As shown, the object 50 also presents the starting and ending time locations of the media fragment and the media segments to indicate to the user 30 what is being linked. Furthermore, the object 50 includes a text fill object 74 that allows the user 30 to enter text describing the relationship between the media fragment in the first media item 36 and the media segment in the second media item 36. The text in the text fill object 74 is saved in the created linking item 44 as a link annotation describing the linking item 44. Upon selecting a “Save Annotated Hyperlink” button 76, the link creation software 42 generates the linking item 44 and stores the linking item 44 within the linking item database 16. In one embodiment, the text fill object 74 may be pre-populated with information related to the linking item, such as suggested keywords based on analysis of metadata of the media fragments and segments being linked. In another embodiment, the text fill object may be replaced with media recorded controls that enable recording annotation information in voice, audio or video format. In addition to text, voice, audio or video annotation information, the user 30 may also provide additional tags, keywords or other metadata that may be associated with the link annotation describing the nature of the annotation, and which may be used to search for or filter linking items. These tags, keywords or metadata may be manually entered in a separate text box (not shown), manually selected from a pre-configured list of options (not shown), or automatically generated based on analysis of the annotation text being entered. This content information may then be stored within or associated with the linking item 44. As will be described in additional detail below, this content information may then be analyzed in relation to user-provided information so that the user 30 can filter and select a desired linking item 44.

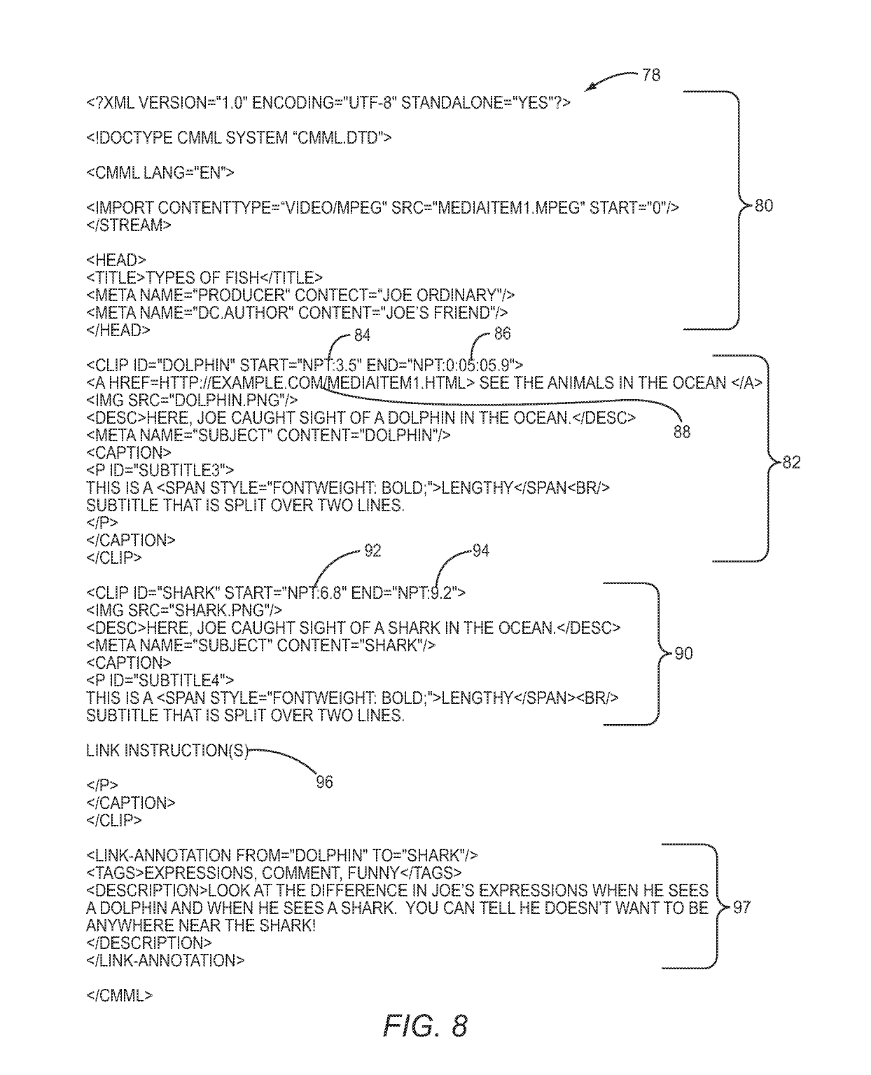

FIG. 8 shows a text-based representation of one embodiment of a linking item 78 created by the link creation software 42. The illustrated linking item 78 is written in an XML-based markup language for time-continuous media items called a continuous media markup language (CMML). While the linking item 78 is written in CMML, it should be understood that the linking item 78 may be written in any format that can define and link media fragments and media segments in the same or a different media item. The linking item 78 links a media fragment and a media segment within the same media item, called “mediaitem1.mpeg.” The linking item 78 has a header 80 which includes annotations and metadata describing the media item as a whole. In this example, a media fragment identifier 82 defines the media fragment, entitled “dolphin,” by indicating a starting time location 84 and an ending time location 86 of the media fragment within the media item. The media fragment identifier 82 includes a media item identifier 88 identifying a storage location of the media item, “mediaitem1.mpeg,” which in this case is a uniform resource identifier (URI). Those skilled in the art will recognize how a URI is used to locate media items.

The linking item 78 also includes a media segment identifier 90 that defines the media segment linked to the media fragment. In this example, the media segment identifier 90 defines the media segment, entitled “shark,” by indicating a starting time location 92 and an ending time location 94 within the media item. The identifiers 82, 90 also have metadata describing the defined media content in the media fragment and the media segment. Linking instructions 96 may then point the media fragment defined in the media fragment identifier 82 to the media segment defined by the media segment identifier 90. The linking items 44 may also comprise user-provided annotations describing the relation between the two or more linked media fragments. This feature is not currently supported in the art, and by CMML. Hence, an exemplary extension to CMML may comprise an annotation segment 97, which contains the user-provided annotation, and identifies the link to which the user-provided annotation applies by indicating the identifiers of two video clips and. Note that the second identifier may contain multiple identifiers, for example as a comma-separated list, since one media fragment may be linked to multiple other media fragments. In one embodiment, the annotation is provided in text format. In other embodiments, the annotation may be in other media formats, such as audio or video, or a combination of audio, video and text. If the annotation is in audio or video format, the annotation segment 97 may comprise a URL segment, containing a URL to the media item that contains the user-provided audio or video annotation. In an alternate embodiment, the binary content of the audio or video annotation itself may be included in the annotation segment 97.

Again, it should be noted that the linking item 78 is only an exemplary representation, and other representations may use different text formats, such as JSON, or other custom XML formats, or various binary formats. Furthermore, linking items 44, may also be stored as data structures in memory or records in a database, and the exemplary CMML-format linking item 78 may only be used when communicating linking information between devices, such as between the server 14 and media player 12. Also it should be noted that one or more linking items 78 associated with a media item 36 may be stored in the same file as media item 36.

In one embodiment where the linking items 44 are maintained at the media item server 14 of FIG. 1, the linking items 44 may be stored as records in the linking item database 16. The linking item database 16 may be, for example, a relational database management system (RDBMS) or a key-value store. Each record may comprise a tuple comprising an identifier for a first media item, an identifier for a fragment within the first media item, an identifier for a second media item, if the media fragment within the first media item links to a second media item, an identifier for a media segment linked to the media fragment within the second media item, and an annotation information item that includes content information related to the linking item 44. In the embodiment where the database is an RDBMS, the records are stored in a table comprising columns corresponding to the elements of the tuple, along with other columns, such as an identifier for the complete linking item itself. Identifiers for media items may be in the form of URLs or URIs or other unique IDs. Identifiers for fragments may be in the form of time locations, or a pair of start and end time locations. Annotation information may be in the form of text, voice, audio or video content, or an identifier, foreign key, URL or file name to locate the annotation in another table, database or on the file system.

Additional columns in the tuple may include other types of content information, such as, the identifier of the user who created the linking item, the overall rating of the linking item, the number of users who selected the linking item, comments made by other users on the linking item 44, other historical usage information of the linking item 44 and so on. This content information may be used, for example, by the filtering software 46 to filter out linking items 44 based on relevancy for a given user. This information may provide social value for users, who may also use it to determine the relevancy of the linking item 44. This information may have operational value for a media server 14 or media player 12, which may examine its rating and historical usage to determine the likelihood that the user may want to execute the linking item 44, and hence may determine whether to buffer the linked media segment.

Relational databases, such as RDBMS, and key-value stores, allow for efficient search and retrieval of the linking items 44 and media items 36. The information in the relational database may be indexed along the columns for identifiers of media items 36, the content information for the linking items 44, and optionally also the identifiers of the media fragment and/or linked media segment associated with the linking items 44. Thus, given an identifier for a media item 36, all linking items 44 created for that media item 36 may be quickly retrieved. Similarly, all linking items for a given media fragment and/or media segment may be quickly retrieved utilizing an identifier for the media content. Furthermore, given user-provided information, such as a keyword or search-term, all linking items 44 with content information that contains the keyword or search-term may be quickly retrieved, along with the respective media item fragments and linked media segments as identified by the media item identifiers and fragment and media segment identifiers in the linking items 44. This can enable, for example, a user to retrieve all linking items 44 that identify spoofs of movie scenes by searching for content information, such as annotations, that contain the word “spoof”.

Note that this database design describes only the structure required for storing and retrieving media linking items. In addition to these, the database may implement other tables to store other content and user-provided information, such as metadata describing the media items 36, user profiles, user comments, ratings, and so on.

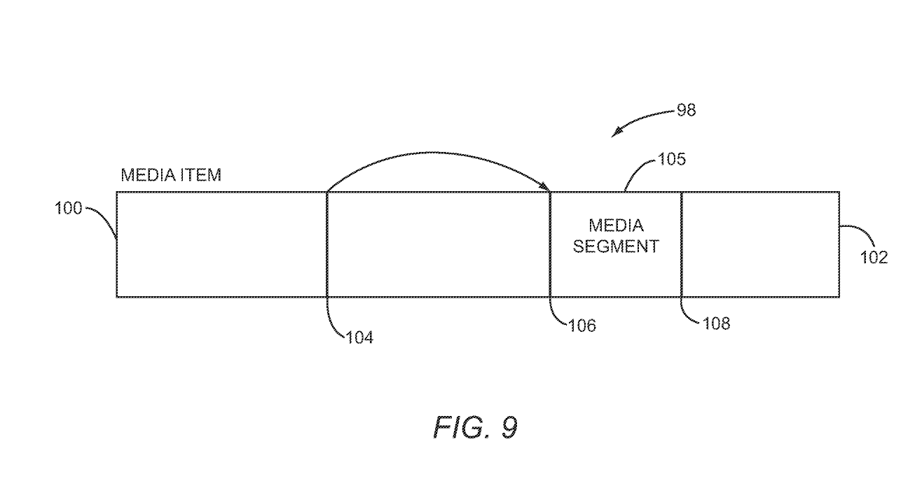

FIGS. 9-14 demonstrate several examples of the operation of different linking items. These figures represent the media content of media items along a continuous time bar with the earliest media content being towards the left of the time bar and the latest media content being towards the right of the time bar. Referring now to FIG. 9, the illustrated time bar represents the media content of a media item 98. Accordingly, the media item 98 begins at a first time location 100 and ends at a final time location 102. In this example, a media fragment 104 is defined by the linking item as a single frame located at a time location within the media item 98. During playback of the media item 98, a media player reading instructions from the linking item may automatically detect when playback has reached the media fragment 104 at the defined time location. The linking item also defines a media segment 105 having a starting time location 106 and ending time location 108. In response to detecting the media fragment 104, the media player automatically implements the linking item and jumps to the media segment 105. The media segment 105 is played beginning at the starting time location 106. Upon reaching the ending time location 108 of the media segment 105, the media player may automatically jump back to the media fragment 104 and play the remainder of the media item 98 or may continue playing past the ending time location 108 until reaching the ending time location 102 of the media item 98.

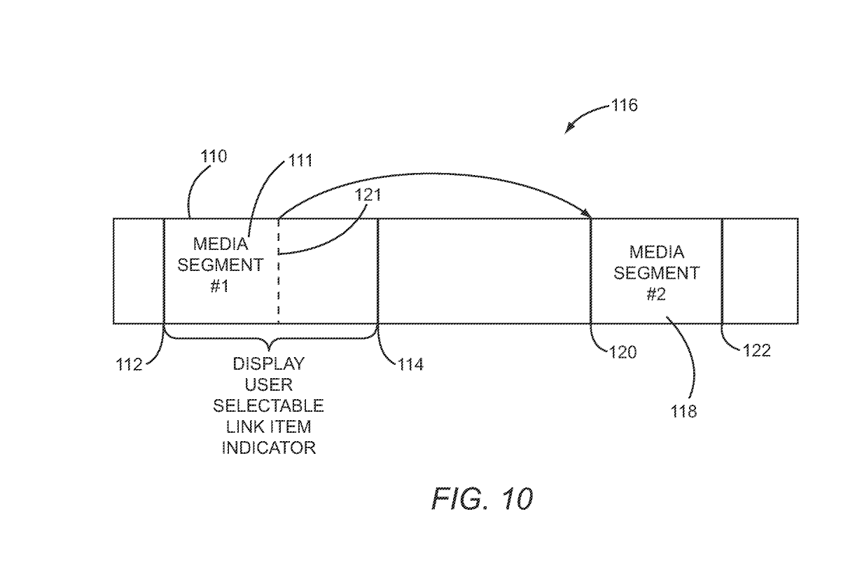

FIG. 10 illustrates the operation of another linking item. In this example, a media fragment 110 is defined by the linking item as a first media segment 111 having a starting time location 112 and an ending time location 114 within a media item 116. During playback of the media item 116, a media player reading the instructions from the linking item automatically detects when playback has reached the starting time location 112 of the first media segment 111. Accordingly, a user selectable link item indicator may be presented for selecting the linking item while the first media segment 111 is being played. In one embodiment where the media segment is in video format, presenting the user-selectable link indicator comprises displaying a graphical icon, a video overlay, or a marker on the visual timeline 52, or other visual indicators in conjunction with the video playback, that the user 30 can interact with, such as by clicking or touching, or by pressing a certain key to indicate selection. The linking item 44 also defines a second media segment 118 having a starting time location 120 and an ending time location 122. If the user selectable link item indicator is not selected, then the user selectable link item indicator is presented until the ending time location 114 of the first media segment 111. Playback of the media item 116 continues without any linking. However, in this example, a user selects the user selectable link item indicator at a time location 121. In response, the media player automatically jumps to the starting time location 120 of the second media segment 118. After the second media segment 118 has been played, the media player may begin playing the first media segment 111 again from the time location 121.

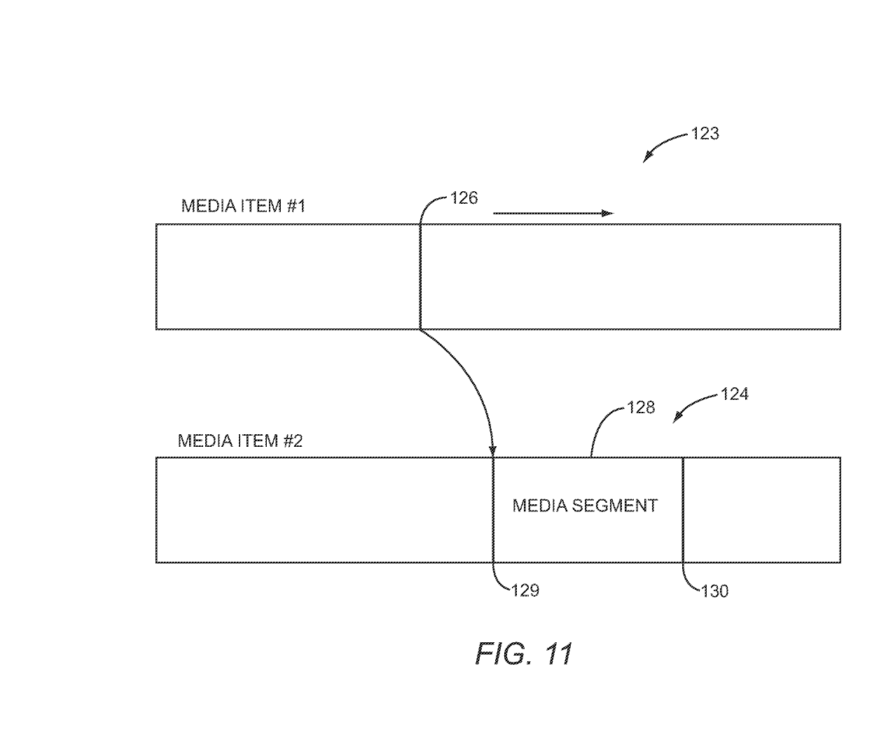

FIG. 11 illustrates the operation of yet another linking item. In this example, the linking item links content from a media fragment 126 to a second media item 124. The inking item defines the media fragment 126 as a single frame at a time location of a first media item 123. During playback of the first media item 123, a media player reading the instructions from the linking item automatically detects when playback has reached the media fragment 126. The linking item also defines a media segment 128 having a starting time location 129 and an ending time location 130 in the second media item 124. In response to detecting the media fragment 126, the media player automatically implements the linking item and jumps to the starting time location 129 within the second media item 124. The media player plays the media segment 128 until the ending time location 130 and is configured to again begin playing the first media item 123 from the media fragment 126.

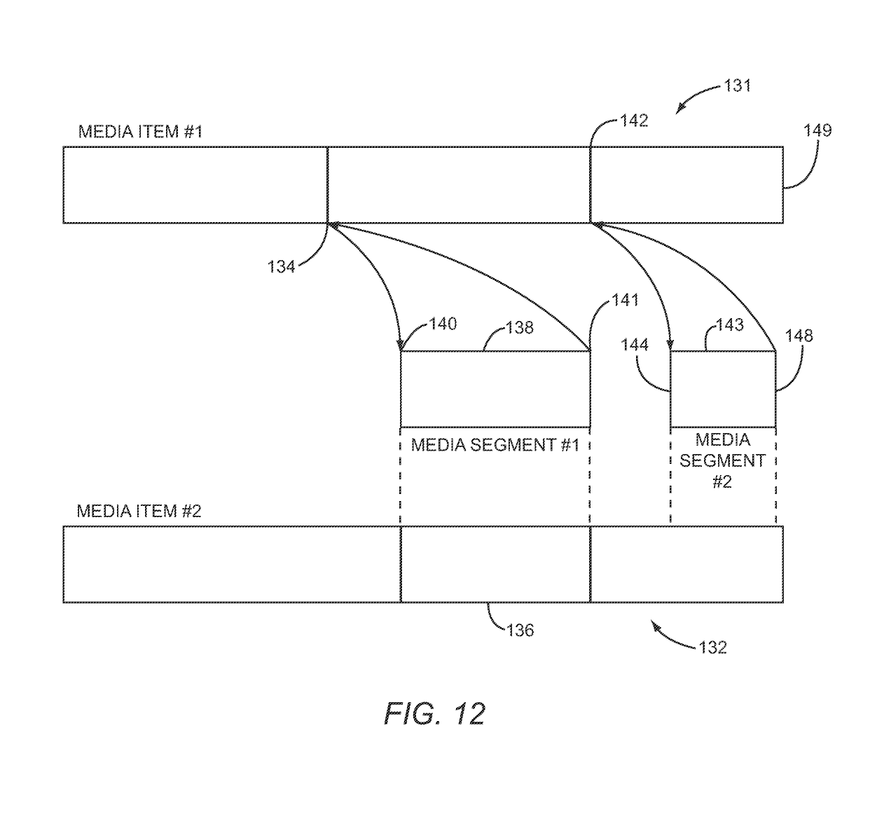

FIG. 12 illustrates the operation of two related linking items. In this example, the first linking item links content from a first media item 131 to a second media item 132. The linking item defines a media fragment 134 as a single frame at single time location within the first media item 131. During playback of the first media item 131, a media player reading the instructions from the linking item automatically detects when playback has reached the media fragment 134. The linking item also defines a media segment 136 from the second media item 132. However, in this example, the media segment 136 has been loaded and stored in a local memory device prior to reaching the media fragment 134 as a first media segment 138. The first media segment 138 includes a starting time location 140 and an ending time location 141. In response to detecting the media fragment 134, the media player automatically implements the linking item and jumps to the starting time location 140 of the first media segment 138. Upon reaching the ending time location 141 of the first media segment 138, the linking item causes the media player to automatically begin playing the first media item 131 from the media fragment 134. The first media item 131 also has a second media fragment 142 linked with a second media segment 143 of the second media item 132. The second media segment 143 has been loaded into a local memory device and has a starting time location 144 and an ending time location 148. Upon playback of the first media item 131 reaching the second media fragment 143, the media player begins playing the second media segment 143 from the second media item 132 at the starting time location 144. When the ending time location 148 of the second media segment 143 is reached, the linking item causes the media player to again begin playing the first media item 131 from the second media fragment 143. The media player continues to play the first media item 131 until reaching an ending time location 149 of the first media item 131.

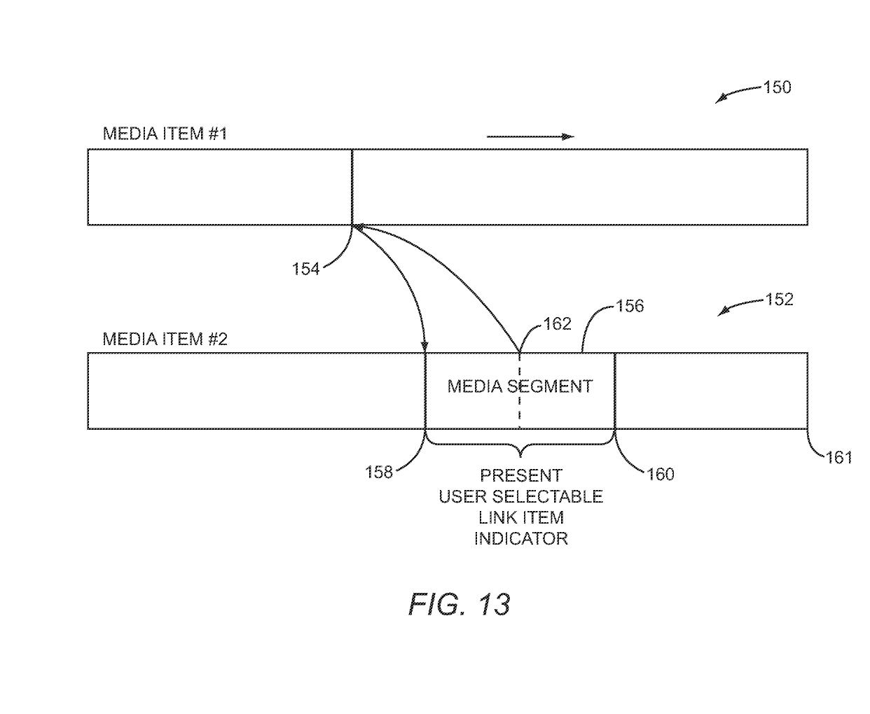

FIG. 13 illustrates the operation of still another linking item. The linking item links content from a first media item 150 to a second media item 152. The linking item defines a media fragment 154 as a single frame at a time location within the first media item 150. During playback of the first media item 150, a media player reading the instructions from the linking item automatically detects when playback has reached the media fragment 154. The linking item also defines a media segment 156 having a starting time location 158 and an ending time location 160 in the second media item 152. In response to detecting the media fragment 154, the media player automatically implements the linking item and jumps to the starting time location 158 within the second media item 152. At the starting time location 158, a user selectable link item indicator is presented for selecting the linking item again. If the user selectable link item indicator is not selected, then the user selectable link item indicator is presented until the ending time location 160 of the media segment 156. Playback of the media segment 156 continues without any linking and the media player plays the second media item 152 until reaching an ending time location 161. However, in this example, a user selects the user selectable link item indicator at a time link location 162. In response, the media player automatically jumps to the media fragment 154 within the first media item 150 and continues playing the fist media item 150 from the media fragment 154 until the end of the first media item 150.

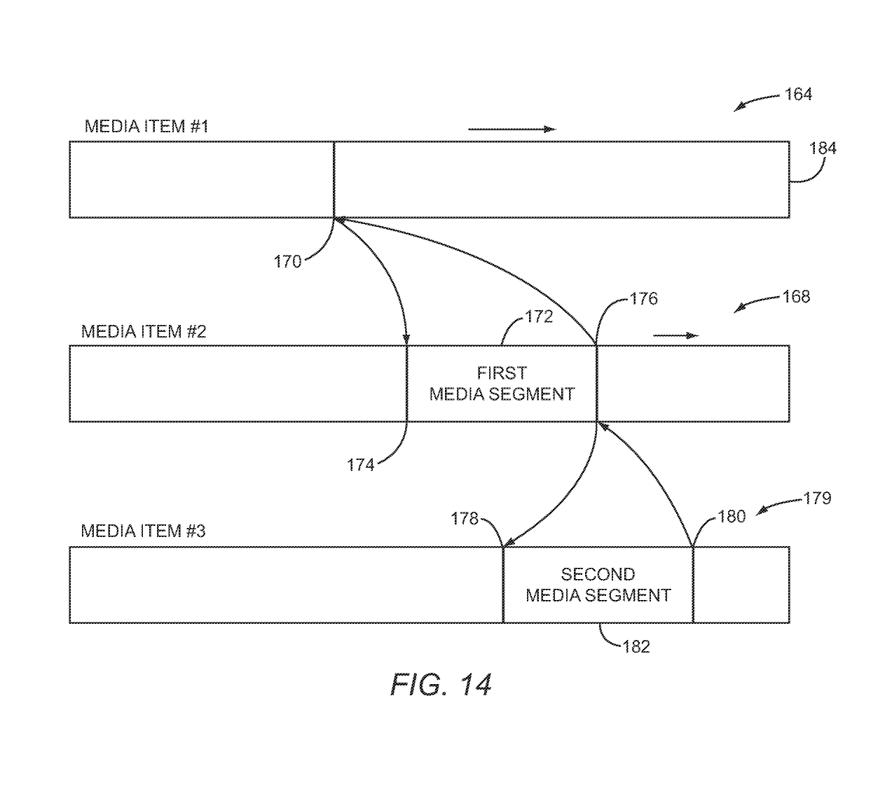

FIG. 14 illustrates the operation of another related first, second, and third linking item. The first linking item links content from a first media item 164 to a second media item 168. The first linking item defines a media fragment 170 as a single frame at a time location within the first media item 164. During playback of the first media item 164, a media player reading the instructions from the first linking item automatically detects when playback has reached the media fragment 170. The first linking item also defines a first media segment 172 having a starting time location 174 and an ending time location 176 in the second media item 168. In response to detecting the media fragment 170, the media player automatically implements the linking item and jumps to the starting time location 174 within the second media item 168. After playback of the first media segment 172 reaches the ending time location 176, the media player determines if a recursive level is less than a pre-configured maximum level of recursion. A recursive level is the number of jumps taken to get from an originating fragment (in this case, the media fragment 170) to the current media segment (in this case, the first media segment 172). In this example, the maximum recursive level is set at the number two (2) meaning that the media player must stop executing linking items after making two (2) jumps.

Accordingly, the current recursive level is one (1) jump and thus another linking item can be implemented. The second linking item defines a media fragment at the ending time location 176 of the first media segment 172. This second linking item links the media fragment at the time location 176 to a second media segment 182 in a third media item 179. Playback of the first media segment 172 continues until the ending time location 176, and then the media player begins playing the second media segment 182 from a starting time location 178. A third linking item links a media fragment at an ending time location 180 of the second media segment 182 to a third media segment (not shown) from a fourth media item (not shown). After reaching the ending time location 180 of the second media segment 182, the media player again determines if the recursive level is less than the maximum level of recursion. In this case, the current level of recursion is two (2) and thus the current level of recursion is not less than the maximum level of recursion. In this case, the media player navigates back and begins playing the first media item 164 from the media fragment 170 until a final time location 184. In this manner, linking items can create successive chains of any size for linking media content but the media player can control the size of the chain by setting the maximum recursion level.

It should be understood that while the above mentioned discussion describes the operation of the linking items as causing actions to be performed at or when a time location has been reached, these actions do not need to be performed precisely at this time location. For example, while the linking item may define a jump from the media fragment to the linked media segment at a particular time location, the linked media segment may need to be buffered in a local memory device before it can be played. There will be a delay once the particular time location is detected before the linked media segment is played. Furthermore, if linked media items are stored in separate servers, there may be a delay between detecting the media fragment on one media item and obtaining the media segment from the other.

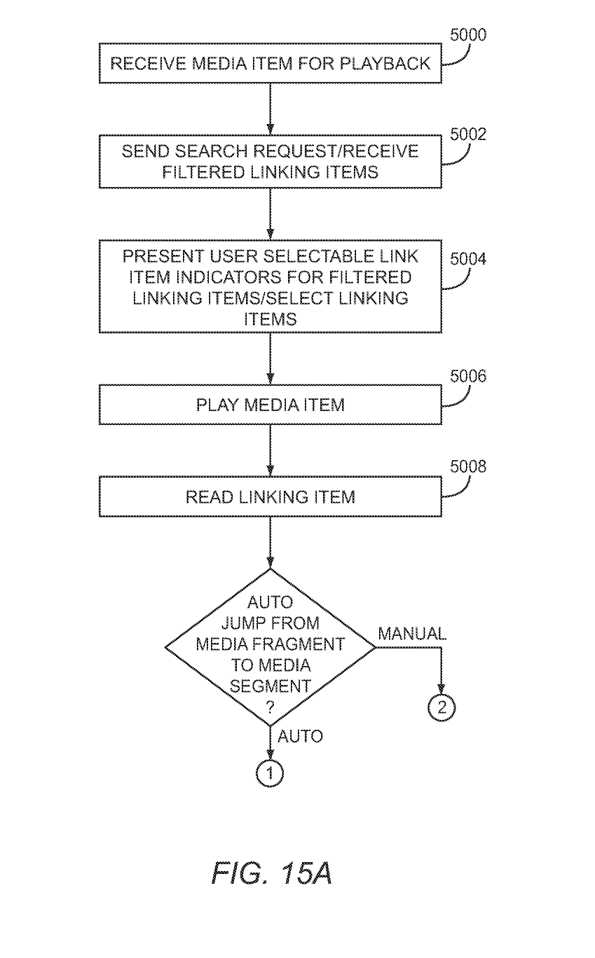

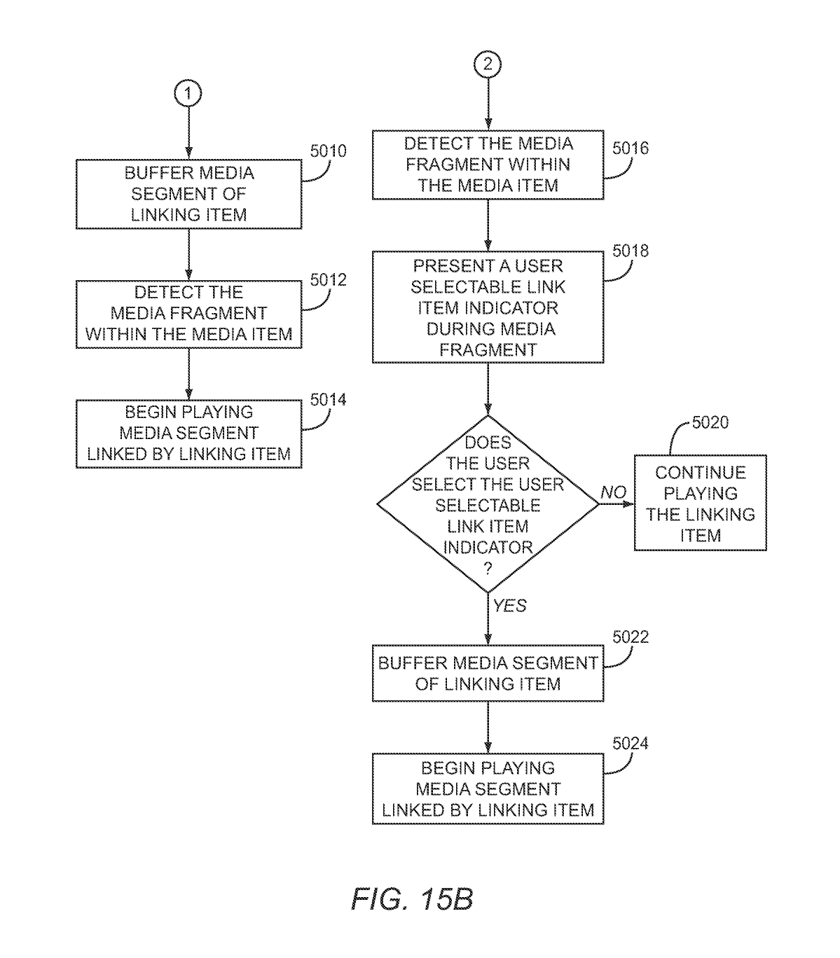

Referring now to FIGS. 15A and 15B, a first embodiment of a method for playing media items 36 with linked media content utilizing the system 10 of FIG. 1 is illustrated. The media player 12 receives a media item 36 from the media item server 14 for playback (step 5000). Once the media item 36 is selected, the user 30 or the media player 12 may transmit a search request to determine which linking items in the linking items database 16 are associated with the received media item 36. The user 30 may also want to further filter linking items 44 associated with the received media item 36 based on desired criteria. To accomplish this, the filtering software 46 in the memory 34 of the media item server 14 receives the search request and filters the linking items 44 in the linking item database 16 (step 5002). The filtering software 46 may also be pre-configured by an operator of the linking item database 16 to filter the linking items 44 based on certain media segments the operator desires for the user 30 to view. Filtering may also be performed based on the user's context. For example, if the user is watching a video that is classified as a parody, the filter may select linking items 44 related to parodies, for example, by selecting linking items 44 with annotation information containing the keyword “parody”, “spoof” and the like. Other filtering or selection methods may compare other types of content information with user-provided information. For example, filtering may include one or more of: comparing keywords or other search terms provided by the user 30 with the annotation information of linking items 44, comparing keywords or other search terms provided by the user 30 with the metadata of the linked media segment, analyzing the historical selection of the linking item 44 by the user 30, analyzing the annotation information of recently selected linking items by the user 30, applying rules configured by user 30 to the linking item annotation information, applying rules configured by user 30 to metadata of the linked media segment, matching the annotation information with the profile of the user 30, matching the metadata of the linked media segment with the profile of the user 30, checking the rating of the linking item as provided by other users, checking the number of other users to have selected the linking item, checking the number of other users with profiles similar to that of the user 30 to have selected the linking item, checking if the linking item has been recommended by other users in the social network of user 30, checking the number of times the linking item has been shared and/or recommended, and so on.

In one embodiment, a user 30 may manually pre-select a sequence of linking items to be traversed by the media player 12. The user 30 may be able to save this custom sequence of linking items 44 and associate it with a user profile or user account. The user 30 may also be able to share this sequence of linking items 44 with other users, for example, other users belonging to his social network. Other users may then provide the sequence to their own media players, which can then traverse the same sequence to receive the same video experience as user 30. The other users may then rate this sequence, or individual linking items 44, and may further share or recommend it to other users. This may enable users to perform video editing activities and exercise creativity in media consumption experiences with relative ease.

In an alternate embodiment, the filtering operation may be performed at the media player 12, by filtering software 25 similar to filtering software 46, residing in the memory 24 of the media player 12. In this embodiment all available linking items 44 associated with the media item 36 may be returned from the media item server 14 to the media player 12, and the filtering operation is performed by the software 25 residing in the memory 24 of the media player 12. In yet another embodiment, filtering may be performed at both, the server 14 and the media player 12, wherein the list of linking items 44 selected by filtering software 46 is transmitted to the media player 12, which then further filters it using the filtering software 25.

As mentioned above, the linking items 44 may include content information, such as metadata and text describing the media fragments, media segments and the relationship between the linked media content. A user 30 searching for certain media content may provide the filtering software 46 with user-provided information describing this media content and/or relationships in a search request. The filtering software 46 may analyze content information within the media items 44 based on the user-provided information to determine if any of the linking items 44 should be presented to the user 30. The content information may also be provided and stored in the linking items 44 in voice, audio, and other multimedia formats and analyzed based on the user-provided information. The content information may also include a user creation identifier identifying a user that created the linking item. If the user 30 desires to exclude or include linking items created by particular users, user-provided information may be included identifying these users. The user 30 may also desire to receive linking items 44 having a particular user rating from a community of users. Content information for the linking items may include a rating for each respective linking item and the user 30 may provide user-provided information defining the desired rating for the linking items 44. Additionally, content information within the linking item may be analyzed based on other types of user-provided information such as a user profile of the user 30 or a collective or aggregate profile of all users that have downloaded the linking item 44. The filtering software 46 analyzes the content information within the linking items 44 based on this user-provided information to determine which linking items are to be presented to the user 30. Furthermore, the operator of the linking item database 16 may pre-configure the filtering software 46 to present the linking items 44 with advertisements or other desired media content.

The user 30 selects from the linking items 44 filtered by the filtering software 46 to determine which linking items 44 are to be executed by the media player 12 during playback of the received media item 36. The filtering software 46 may then present the user 30 with user selectable link item indicators for selecting from the filtered linking items 44. The user 30 may then select one or more of the user selectable link item indicators to select the linking items 44 for implementation by the media player 12 (step 5004). In alternate embodiments, the user 30 may configure the media player 12 to automatically select all or a subset of the filtered linking items 44 by providing user provided information similar to that used by the filtering software, such as based on the user-generated rating of the linking items 44, comparison of the linked media segment metadata to the profile of the user 30, comparison between the profile of the user 30 and the profile of the user that created a linking item, and so on. This may enable the user 30 to begin playback immediately without having to manually select linking items 44.

The media item player software 26 within the media player 12 plays the selected media item 36 (step 5006) and reads the information within the selected linking item(s) 44 (step 5008). If the selected linking item 44 is configured so that the media player 12 automatically jumps from the media fragment in the selected media item 36 to the linked media segment, the media player 12 may go ahead and buffer the corresponding media segment (step 5010, FIG. 15B). In this case, the media player 12 detects the media fragment and automatically begins playing the linked media segment (steps 5012 and 5014).

On the other hand, if the linking item 44 is not configured to automatically jump to the linked media segment, the media player 12 first detects the media fragment which, in this case, presumably is a media segment (step 5016, FIG. 15B). A user selectable link item indicator for implementing the linking item 44 is presented while the media fragment is playing (step 5018). If the user 30 does not select the user selectable link item indicator, the media player 12 continues playing the media item 36 and no linking occurs (step 5020). However, if the user 30 does select the user selectable link item indicator, the linked media segment is buffered (step 5022) and played (step 5024) by the media player 12. In an alternate embodiment, the media player 12 may optimistically buffer, either partially or wholly, the linked media fragment even before the user 30 makes a selection. It may buffer only a small portion of the media segment in order to reduce the buffering delay in case the user does opt to select the user selectable link item indicator. However, if the user 30 does not select the user selectable link item indicator, the buffered media segment is not needed, and hence may be discarded. Hence, this strategy is preferable when the media player 12 has sufficient bandwidth available, and may not be ideal in more bandwidth-constrained scenarios.

Note that in addition to enabling a user to select a linking item to traverse, the user selectable linking item indicator may also offer users options to rate the linking item, comment on the linking item, and share or recommend the linking item with other users.

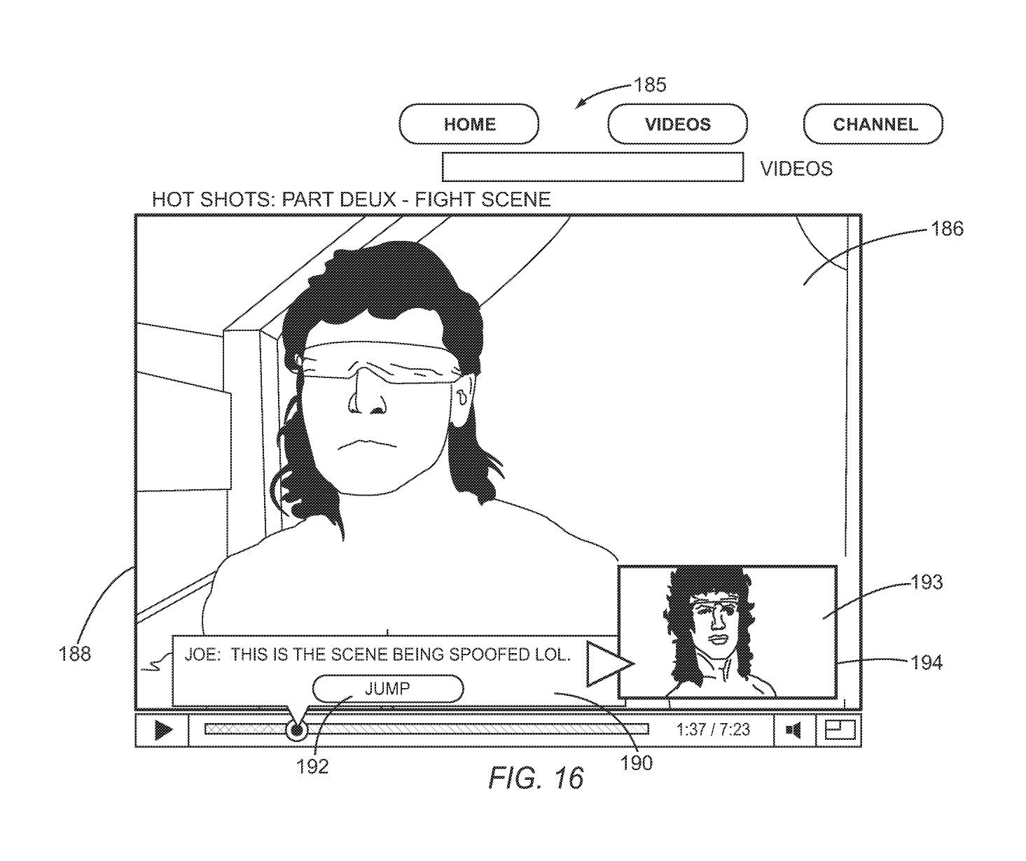

FIG. 16 illustrates a screenshot of one embodiment of a graphical interface 185 for playing a media item 186. A display object 188 presents the media item 186 during playback. In this example, the media player has detected the media fragment and presents a user selectable link item indicator 190 to the user. The user selectable link item indicator 190 includes a jump button 192 and a preview object 194 showing a media frame of a linked media segment 193. Upon selecting the jump button 192, the graphical interface 185 presents the linked media segment to the user.

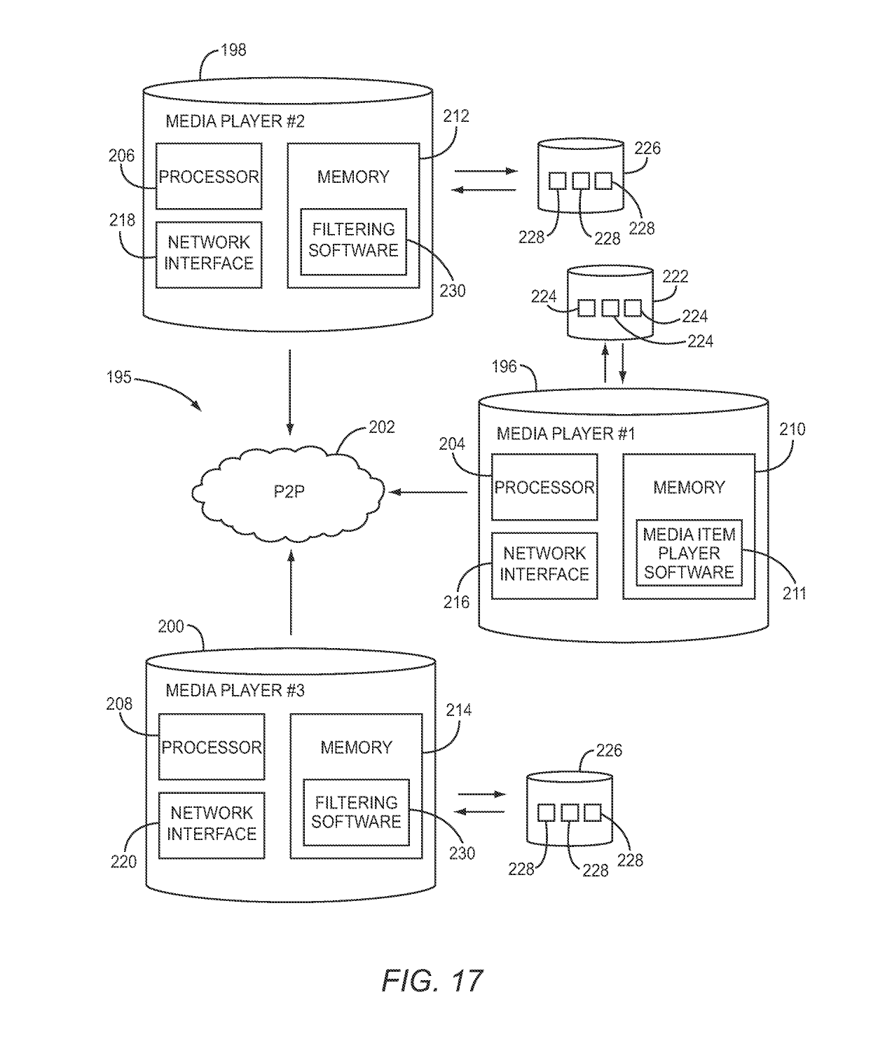

FIG. 17 illustrates a second embodiment of a system 195 for creating and playing linked media content. The system 195 includes a first media device 196, a second media device 198, and a third media device 200, all coupled to one another via a peer-to-peer (P2P) network 202. Each media device 196, 198, 200 includes a processor 204, 206, 208, respectively, and memory 210, 212, 214, respectively. Also, the media devices 196, 198, 200 are coupled to one another via the P2P network 202 utilizing network interfaces 216, 218, 220, respectively. In this example, the media devices 196, 198, 200 may be personal computers. A media item repository 222 is coupled to the first media device 196 to store a plurality of media items 224, and media item player software 211 in the memory 210 of the first media device 196 is configured to play the media items 224. The media devices 198, 200 are coupled to a linking item repository 226 that includes linking items 228. Filtering software 230 in the memory 212, 214 of the media devices 198, 200 filters the linking items 228 as described above. In this manner, the first media device 196 may search and receive linking items 228 stored in the linking item repositories 226 of a variety of users. If the media devices 198, 200 also store other media items (not shown), the first media device 196 may also obtain linked media segments from the media devices 198, 200 of other users.

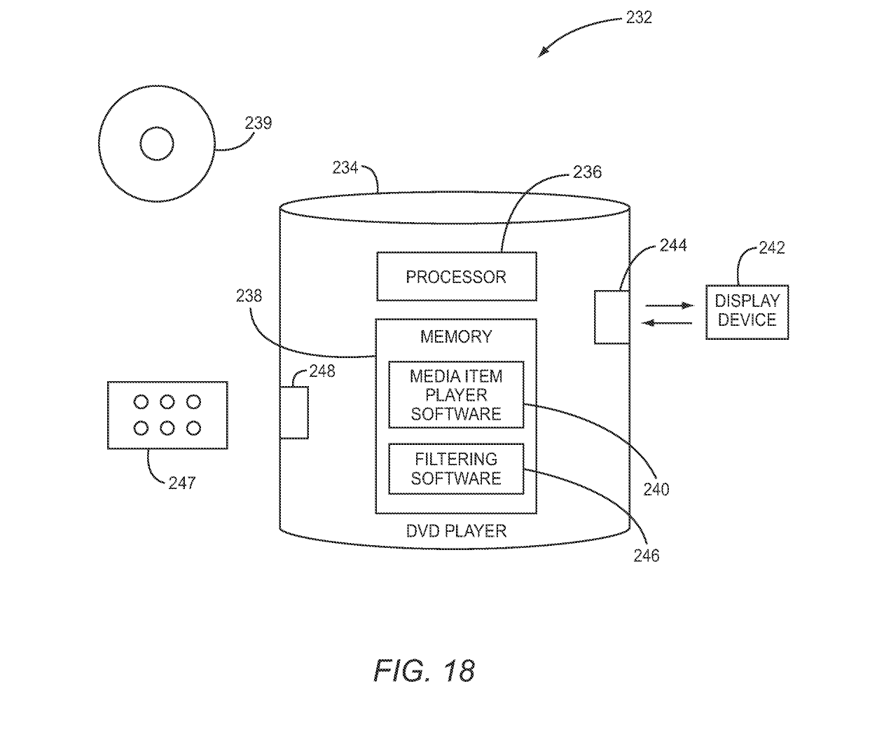

FIG. 18 illustrates a third embodiment of a system 232 for playing linked media content. The system 232 includes a media player, which in this example is a DVD player 234. The DVD player 234 includes a processor 236 operably associated with memory 238. A portable storage medium, such as a DVD 239, stores media and linking items. In this case, the linking items may actually be stored within the media items themselves. The DVD 239 is inserted into the DVD player 234 to play the media items stored on the DVD 239. Media item player software 240 in the memory device 238 reads the DVD 239 and transmits audio/visual signals to a display device 242, such as a television, via an output device 244. Filtering software 246 may allow a user to search through the linking items stored on the DVD 239. In other cases, the DVD player 234 may automatically present user selectable link item indicators when a particular media item is being played. In this manner, the user can navigate through linked media content on the DVD 239. A user may send commands to the DVD player 234 via a remote 247 to a remote interface 248 on the DVD player 234.

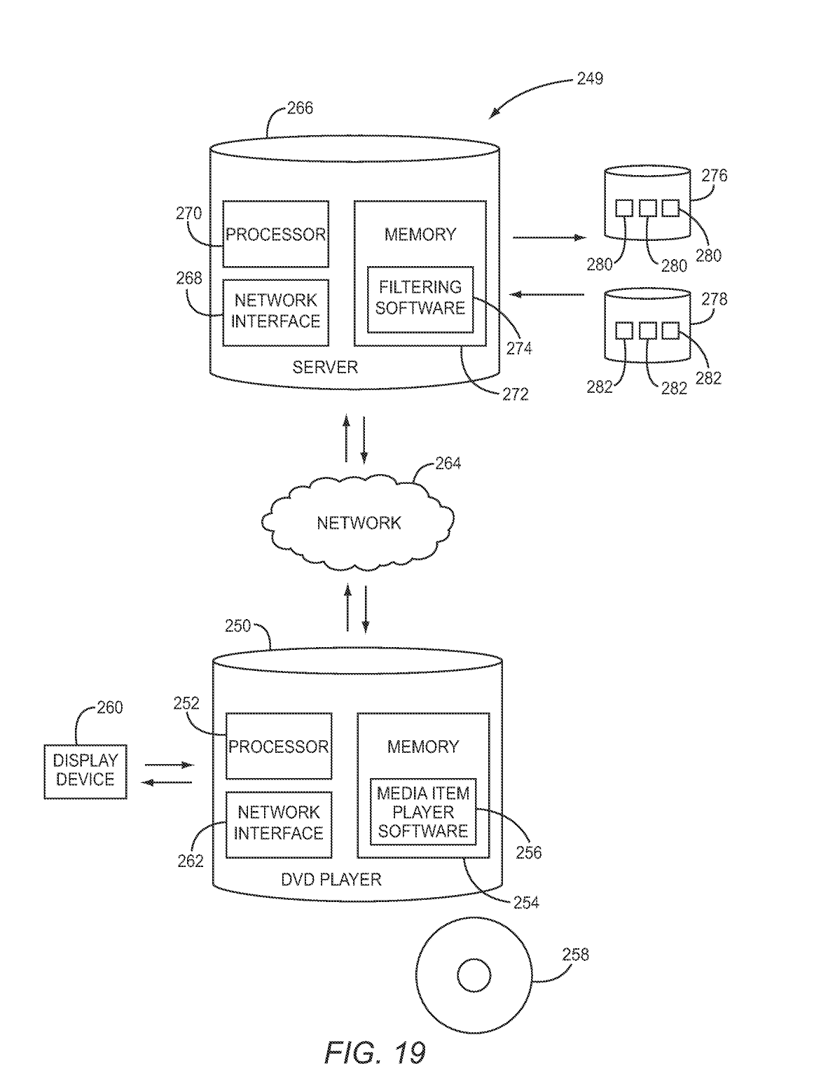

FIG. 19 illustrates a fourth embodiment of a system 249 for playing linked media content. The system 249 includes a media player, such as a DVD player 250, having a processor 252 operably associated with memory 254. The memory 254 includes media item player software 256 for playing different types of media items and presenting them to a user via a display device 260, such as a television. A portable storage medium, such as a DVD 258, includes media items for presenting media content to the user through the display device 260. In this example, the DVD player 250 is coupled via a network 264 to a media item server 266. The media item server 266 allows the DVD player 250 to link media items on the DVD 258 to media content stored remotely on the media item server 266. The media item server 266 includes a network interface 268 to connect to the DVD player 250 via the network 264 and provide linking items and media content to the DVD player 250. The media item server 266 also manages a media item repository 278 which stores a plurality of media items 282 having media content which can be linked by linking items 280 in a linking item repository 276 to media content on the DVD 258. A processor 270 in the media item server 266 is operably associated with memory 272 and executes filtering software 274 for filtering linking items 280 and media item 282, as described above. In this manner, a user can watch the DVD 258 on the DVD player 250 and use the filtering software 274 to search for media content associated with the media items on the DVD 258. Also, other parties may provide media content to the DVD player 250 in accordance with the media items on the DVD 258. For example, if the DVD 258 includes a movie from a particular movie studio, the movie studio can present the user with linking items 280 from the linking item repository 276 having the latest movie previews for movies from the movie studio.

Those skilled in the art will recognize improvements and modifications to the preferred embodiments of the present disclosure. All such improvements and modifications are considered within the scope of the concepts disclosed herein and the claims that follow.

What is claimed is:

1. A method of linking media content, comprising:
receiving a first user input defining a media fragment within a first media item;
receiving a second user input defining a first media segment that is discrete from the media fragment within the first media item;
creating a linking item linking the media fragment within the first media item to the first media segment wherein the linking item is associated with the first media item; and
storing the linking item.

2. The method of claim 1, wherein the media fragment is located at a single time location within the first media item.

3. The method of claim 1, wherein the media fragment is a second media segment within the first media item.

4. The method of claim 1, wherein the first media segment is located within the first media item.

5. The method of claim 1, wherein the first media segment is from a second media item.

6. The method of claim 1, further comprising:
receiving a request for the first media item from a media player; and
returning the first media item and the linking item to the media player.

7. The method of claim 6, wherein the linking item is configured to cause the media player to play the first media segment when playback of the first media item has reached the media fragment.

8. The method of claim 1, wherein the linking item comprises:
a media fragment identifier identifying the media fragment; and
a media segment identifier identifying the first media segment.

9. The method of claim 8, wherein the media fragment identifier includes a first media item identifier that identifies a storage location of the first media item.

10. The method of claim 8, wherein the media fragment identifier indicates at least one time location which locates the media fragment within the first media item.

11. The method of claim 8, wherein:
the media segment is from a second media item; and
the media segment identifier identifies at least one time location within the second media item.

12. The method of claim 11, wherein the linking item is also associated with the second media item.

13. The method of claim 1, wherein the linking item includes content information regarding an association between the media fragment and the first media segment.

14. The method of claim 1, wherein the linking item is stored within the first media item.

15. The method of claim 1, further comprising:
creating one or more additional linking items associated with the first media item, each additional linking item linking a corresponding media fragment within the first media item with a corresponding media segment discrete from the corresponding media fragment; and
storing the additional linking items associated with the first media item.

16. The method of claim 15, wherein creating one or more additional linking items associated with the first media item includes creating at least one additional linking item in which the corresponding media segment is from a second media item.

17. The method of claim 16, further comprising creating another additional linking item associated with the second media item, the another additional linking item linking the corresponding media segment from the second media item with another media segment discrete from the corresponding media segment from the second media item.

18. The method of claim 17, wherein the another media segment is from a third media item.

19. The method of claim 1, further comprising storing a plurality of media items, the first media item being one of the plurality of media items.

20. The method of claim 19, wherein prior to receiving the first user input and the second user input, the method further comprises receiving a third user input that selects the first media item for linking media content.

21. The method of claim 20, wherein prior to receiving the first user input and the second user input, the method further comprises receiving a fourth user input that selects a second media item from the plurality of media items for linking media content.

22. The method of claim 1, wherein receiving the first user input defining the media fragment within the first media item further comprises:
presenting the first media item in association with a first visual timeline wherein the first visual timeline corresponds to first media item time locations within the first media item; and
wherein receiving the first user input comprises receiving user input that selects the media fragment by selecting at least one of the first media item time locations within the first media item using the first visual timeline.

23. The method of claim 22, further comprising:
presenting a second media item along with a second visual timeline wherein the second visual timeline corresponds to second media item time locations within the second media item; and
wherein receiving the second user input further comprises receiving user input that selects the first media segment by selecting at least one of the second media item time locations within the second media item using the second visual timeline.

24. A device for linking media content, comprising:
an interface for receiving user inputs from at least one user; and
one or more processors operably associated with the interface and being adapted to:
receive a first user input defining a media fragment within a media item;
receive a second user input defining a media segment that is discrete from the media fragment of the media item;
creating a linking item linking the media fragment to the media segment; and
store the linking item.

25. The device of claim 24, further comprising one or more digital storage mediums, the one or more digital storage mediums storing a plurality of linking items associated with the media item, each linking item of the plurality of linking items being configured to link a corresponding media fragment within the media item to a corresponding time segment discrete from the corresponding media fragment within the media item.

26. The device of claim 25, further comprising at least one of the one or more digital storage mediums.

27. The device of claim 25, wherein the device is operably associated with a network and the one or more digital storage mediums are on a remote database coupled to the network.
